(19) United States
(12) Patent Application Publication
(10) Pub. No.: US 2025/0318706 A1
(43) Pub. Date: Oct. 16, 2025

(54) STAIN REMOVAL DEVICE

(71) Applicants: JAMES ANDREW CAMERON, BILLINGS, MT (US); LORI MARIE CAMERON, BILLINGS, MT (US)

(72) Inventors: JAMES ANDREW CAMERON, BILLINGS, MT (US); LORI MARIE CAMERON, BILLINGS, MT (US)

(73) Assignee: Rascal Innovations, div. of Crazy Mountain Venture, BILLINGS, MT (US)

(21) Appl. No.: 18/737,877

(22) Filed: Jun. 7, 2024

Related U.S. Application Data
(60) Provisional application No. 63/632,764, filed on Apr. 11, 2024.

(51) Int. Cl. A47L 13/26; A47L 13/17; A47L 25/08; B05C 17/005; B24B 23/00

(52) U.S. Cl. CPC A47L 13/26; A47L 13/17; A47L 25/08; B05C 17/00596; B24B 23/00

(57) ABSTRACT

The present invention relates to a portable geometrically rectangular or octagonal applicator device for stain removal, et alia referred to as “octa-rectangular”; Or other complex geometry of higher capacity than a simple round tube-type pen. More specifically claimed and described is a device comprising one, two, or more of either; refillable or sealed reservoir(s) whereby formulations are conveniently dispensed, with precision, from the applicator device(s) or nub(s). The device also comprises various integrated stain lifting, scrubbing, or cleansing pads for lifting stain debris and/or applying frictional stress upon the treatment material.

### FIELD OF THE INVENTION

The invention pertains to a portable stain removal device and its application. The present invention relates to integrated stain removal, lifting, and abrading features as well as refillable reservoir(s) of a multifunctional compact and portable carry applicator device for targeted stain removal upon the treatment material.

### PRIOR ART

Portable dissimilar stain removal devices, for pre-treatment and on demand treatment, are known articles of manufacture. Prior art examples are: “Tide To Go” instant stain remover pen granted patent in 2003 and expired in 2022 (US Pat. Nos. US20030035680A1 and U.S. Pat. No. 6,644,879B2). Since this patent expired: Oxiclean On-the-Go Pens, Whip-it Emergency Stain Removing Pens, and various bleach pens are of the same disparate uncreative tube design and principle.

All these unimaginative devices have many limitations and lack versatility for the intended utility such that they cannot reasonably be considered equal when compared to the present invention. The old “stain pen” devices:
1. comprise only one applicator nub or tip.
2. have no enhanced and integral abrading devices for: lifting, cleansing, or scrubbing the treatment material.
3. are factory sealed plastic tubes with a singular harsh chemical formulation.
4. are disposable after few uses, thus repetitively polluting our world with plastic waste and forever chemicals.
5. are dependent on a limitative “one size fits all” sealed factory chemical formulation predictably only effective on +/−60% of stains attacked.
6. Warn against Color transfer, dye fading, and discoloration of the treated material due to a singular harsh bleach or solvent based formulation that defeats some stains but also can ruin the treated material. Hence prior art compromises, by providing a mild formulation that they hope works on some stains, while attempting to not damage the treatment material. This translates to a 60% stain removal success rate dependent on stain composition and treatment material. How would it be if your cell phone only sent or received 60% of texts? Or your printer worked 60% of the time?
7. are cylindrical, ovular, or tubular manufactured sealed-reservoir devices; Cheap to manufacture but lack volume. A low-capacity limitation precludes multiple stain removal procedures.
8. suggest varying optimal frictional stresses upon the treatment material based on one very limited soft-tipped applicator/abrader. Describing this applicator as possessing a hypothetical abrading friction of 0.2 N mm⁻² to 10 N mm⁻² is overly broad speculation which fails to efficiently adapt to different treatment materials or different stain compositions.
   Other Drawbacks Associated with Prior Art:

Tube shaped “stain pens” on the market disclaim: “Does not work on grease, blood, ink”. And “Eye Irritant”, “Harmful if swallowed”. Further warnings include: “gas-build up inside the applicator may affect the controlled delivery of the formulation or may become a safety hazard”, “Always test on an inconspicuous area first”, “not recommended on silk, sued, or leather”, and “Use only on machine washable fabrics”. Yet more shortcomings: They run out of formulation (due to +/−10 ml low capacity), leak, and dry up during storage. Many devices also teach an inconvenient multi-stage treatment using heat, water, rinsing, and tools such as an iron. It is obvious, and even admitted on the packaging “stain pens” are inefficient and, at times, damage the dye or appearance of the treatment material. The present invention is multi-functional and is not a tubular stain pen.

### Specific Prior Art in this Field Includes the Following

U.S. Pat. No. 5,765,407 describes an on-the-spot stain removal kit, comprising four sponges, and teaches a four-step stain removal procedure for satisfactory results. U.S. Pat. No. 5,122,158 discloses an applicator for an enzyme-containing liquid detergent for pre-treatment application in laundry preparation. The applicator comprises a semi-porous body made of a synthetic plastic material. The heat resulting from friction produced by the applicator during application to a fabric is assumed to stimulate rapid enzymatic reaction.

U.S. Pat. No. 5,872,090 discloses a stamp like applicator for fabric treatment utilizing bleach and surfactant. It is to be applied in a rocking motion and preferably done on a tabletop using an absorbent stain remover situated beneath the fabric. Then followed by a post-treatment process in a hot air cloth dryer.

U.S. Pat. No. 5,288,420 discloses stain removal in the form of a solid stick, which can be applied to selected areas of a fabric as a first step or pre-treatment in laundry preparations. Various formulations are disclosed comprising surfactants, enzymes and glycols. U.S. Pat. No. 3,748,268 discloses an aerosol stain removal formulation especially for carpets and upholstery and comprising a surfactant.

People having ordinary skill and familiarity with stain removal devices are aware of the limitations and disappointments found in “stain removal pens”. None of the prior art recognizes or embodies the advantages of multiple and refillable formulations, high capacity, or friction variety in attacking specific stains and treatment materials. Hence the need to invent a non-cylindrical, multi-functional, high capacity, eco-friendly “better mousetrap”. A discussion of the state of any alleged prior art known to the applicant, including specific references has been hereby memorialized. They are not at all comparable to the present invention. No evolution or innovation of new designs or utility has been discovered in search of any potential prior art.

### SUMMARY OF THE INVENTION

The objective of the present invention is to pioneer a compact and portable geometrically inimitable applicator device with refillable reservoir capability. “Stain pen” devices fail in as much as 40% of all stain removal attempts due to their singular formula limitation. The objective then, of the present invention is greater utility; Attacking a stain with varied formulations and additional integrated abrading techniques, thereby defeating as much as 90% of a variety of stains.

Due to its superior geometric design and refillable multi-reservoir structure the present invention solves many shortcomings found in earlier devices: a. Superior reservoir(s) capacity in the same compact length and portability. b. Integrated stain lifting, rubbing, cleansing, scrubbing, and abrading features unavailable in dissimilar unsophisticated devices. c. Multiple formulations carried and instantly available. All of this is further evidence of innovative utility.

The present invention addresses an important technical problem of existing rudimentary devices. Filling the device reservoir(s) with different chemical or natural formulations, specific to the stain composition attacked, enhances utility. The present invention allows the user to economically source and instate homemade or natural formulations for people with chemical sensitivities, reactions, or allergies also increases utility. And refillable use also reduces plastic and chemical pollution of our world. Hence the invention is more successful, safer, more eco-friendly, and sustainable.

### DETAILED DESCRIPTION OF THE INVENTION

The present invention incorporates hollow octa-rectangular reservoir(s) which contain distinct formulations for stain removal (Ref Marks 4 & 6). Such a housing may be any shape or size of a higher capacity in comparison to the banal low capacity tubular or ovular geometry of prior art. Or may be offered as two or more separate “mini” single applicator devices which are more compact and shorter than prior art due to the octa-rectangular design (FIG. 4). And packaged together and marked “Formulation A”, Formulation “B”, and/or “Refill device”. The preferred multipurpose version of the present invention tapers at each end to two different applicator tips, ends, bibs, or nubs. Et alia referred to as “nubs” (Ref marks 3). And with abrading cap devices mounted and integrated to the device for lifting, cleansing or scrubbing the targeted stain (Ref marks 2 & 7). The device is compact and convenient to hold in the user's hand.

The present invention is most effective in defeating a much wider spectrum of difficult stains with efficiently low amounts of formulation used. Adjustable frictional stress values support proficient treatment through abrading selectability to effectively remove the stain but not cause damage to the treatment surface. Additionally, varied custom formulations “loaded” into the device lend a most effective stain removal process. In essence, the present invention is versatile, adaptive, refillable, high capacity, and multi-formulation; Vastly improving Utility.

### Design:

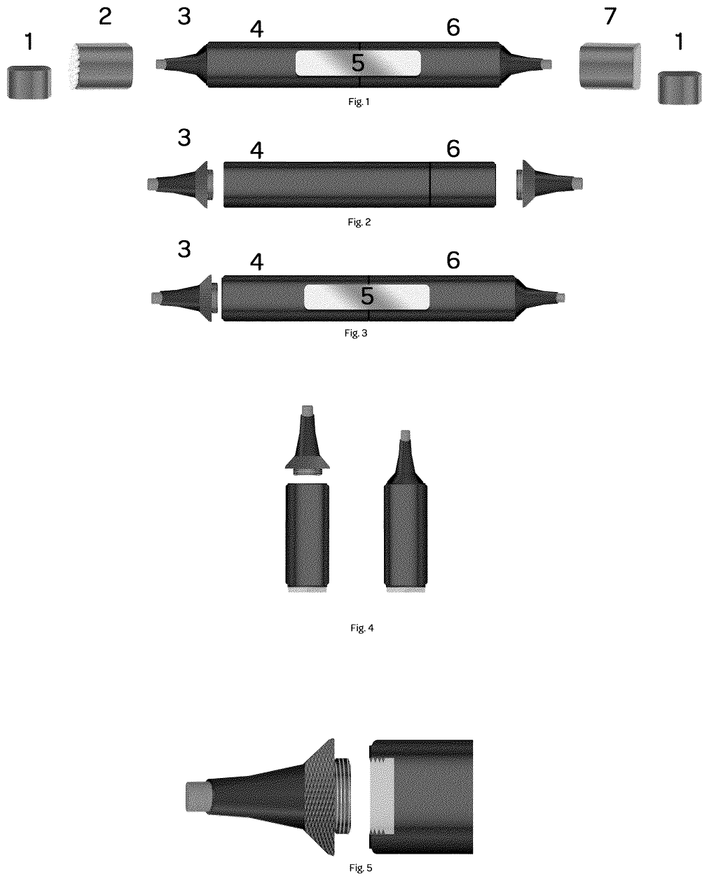

It is geometric fact that a rectangle vs. a circle have significantly differing areas, or in the case herein; A rectangular cube vs. a cylinder or tube; Differing volumes. Hence, given the same length, an octa-rectangular geometry reservoir(s) yields approximately twice the formulation capacity of a tube reservoir. Preferred dimensions for portability are +/−2.25 cm H×+/−2.75 cm W×+/−12 cm L. The multi-use version of the present invention has more than one reservoir(s) in the same compact and portable +/−12 cm length device. If configured equally, each reservoir will hold a volume of +/−10 ml, which is double that of a similar length tube type reservoir. The present invention may be of any reasonable size or non-tube geometry variation other than the preferred embodiment mentioned above. However, the preferred length to width ratio of the dual reservoir variation will be between 1:4 and 1:5 to allow the device to be easily held and used in the hand. The present invention comprises more than one reservoir(s), which reservoir(s) may or may not be of the same size and volume (FIGS. 2, 3, & 4). Each reservoir(s) may or may not be refillable.

The preferred embodiment of the present invention is refillable. However, either, both, or none of the reservoir(s) may have various access design elements for refilling (FIG. 5). For example, FIG. 3 depicts one factory sealed end and one refillable reservoir with a threaded applicator end which, when removed, allows access to just one reservoir for refilling. The other reservoir may contain a factory provided formulation or also be configured for refill as in FIG. 2. The design illustration for access to a refillable reservoir of the present invention is the removable or screw-on applicator nub as depicted in FIG. 5. Being more than 1.0 cm in overall diameter and comprising a 6 g class male thread of M10×10 mm, with the nub being +/−5 mm in diameter, which will yield a reasonable flow efficiency of formulation from 0.001 ml mm⁻²s⁻¹ to 0.01 ml mm⁻²s⁻¹. The flow rate is variable and adjustable based on downward pressure on the device by the user which retracts the nub allowing formulation to flow. Other refill access and design features may be part of the device such as a leak proof valve hole typical of sports equipment.

The present invention has integral cleansing, lifting, or scrubbing devices to enact optimal mechanical performance and induce varied amounts of frictional stress upon the treatment material (Ref Marks 2, 5, & 7). Additionally, the improved cylinder-shaped nub with a flat tip exerts more surface area and more overall frictional stress upon the treatment material (See FIG. 5). Regardless of the formulation deployed, optimal frictional stress is critical to successful stain removal. The frictional stress must not be so high as to induce damage upon the treatment material however the frictional stress must be high enough to ensure effective mechanical stain removal and intensive precision conveyance of the formulation into the fibers of the treatment material. Additionally, availability of devices of friction variation is also critical to success. The term frictional variation referred to et alia means the different types of abrading devices as they are effective for different stains and materials. For simple example: One does not use a wire brush on a silk fabric, nor is the use of a smooth nub effective on denim or other robust fabrics. One does not use a 3M type lint roller tape or a car cleaning gel pad (Ref Mark 5) to remove embedded grass stains on cashmere, etc.

A person skilled in the art of stain removal is aware variable intensities of frictional stress and abrading devices are necessary for efficient stain removal. The present invention embodies varied and integrated cleansing, lifting, rubbing, scrubbing, and abrading pads specific to: the particular stain, the optimal frictional stress needed, and the treatment material. They are deployed as follows: Smooth applicator nubs are used to abrade stain material on delicate materials. The integrated cleansing pad is for medium abrading. The tape or gel type lifting pad is for pre-treatment or post-treatment removal of stain debris or other dry debris such as lint, hair or dust. This novel feature dabs or pulls up stain debris or residue, by adhesion, particularly on very delicate materials such as silk, cashmere, and satin. The size and location of the lifting pad can be circumferential and multi-layered or of any reasonable fixed size upon the device. The scrubbing brush is for more aggressive abrading on more robust treatment materials (See Ref Marks 2, 5, &7 for abrading devices). The applicator also comprises caps to prevent evaporation or leaking of the reservoir(s) formulation when not in use (See Ref Marks 2&7). Also, abrading end features may be covered with their own caps to prevent inadvertent contact of the cleaning pads with other items (See Ref Mark 1). The abrading features can be 3M type lint tape, gel pads, felt, fabric, nylon, polyester, plastic mesh, polypropylene, cellulose, natural fibers, synthetic stipples or a combination of any usual brush or pad materials. As an additional benefit, these abrading features reduce the amount of formulation necessary for successful stain removal. Finally, either, some, or all, these abrading features can be integral to the device.

The preferred material of the present invention is polypropylene, polymer or other plastic, but it may be made of other materials. And may be flexible or rigid in composition. The cylinder-shaped and flat-end applicator nub may be: sponge, polyethylene, felt, synthetic, solid, roller style; Or another porous type dispenser, pad or brush type tip. The preferred embodiment of the applicator tip is to precisely control the flow of the formulation in a targeted manner to the treatment area as well as provide gentle frictional abrading of the treatment material.

### Further Embodiments

One objective of the present invention is to attain +/−90% success in attacking and removing a comprehensive spectrum of stains such that the user can have greater confidence over the banal factory sealed 60% success “stain pens” currently available.

The preferred embodiment of the present invention applies formulation either with the garment worn or removed. It is still a further objective of the present invention to provide an applicator for a treatment formulation which does not leave residues, does not typically require a post-treatment rinse or other post treatment of the material. Additional steps such as heat, rinsing, and drying are normally not needed since the formulations used are generally residue free and quick drying. And the applicators apply targeted low amounts of treatment formulations to precise areas.

Another embodiment of the present invention is to provide adaptability with two different formulations available. Thereby addressing the full spectrum of stains the owner wishes to defeat; Grease, tar, coffee, oils, blood, adhesives, berries, chocolate, condiments, baby formula, sauces, cosmetics, nail polish, grass, pet urine, collar ring, dairy, egg, ice cream, mildew, cuff stain, syrup, tobacco, wine, chewing gum, paint, resin, nail polish, lipstick, ink, ketchup, salsa, fruit juice, etc.

Yet another embodiment of the present invention is the use of one applicator and formulation as a pre-treatment, followed by the second applicator and formulation as an extra, sanitizing, or final treatment. This depends on the user's configuration and the composition of stain being defeated. The present invention, configured with two refillable reservoir(s) can accommodate this scenario with perfect utility.

Another embodiment of the present invention that adds utility is the selection and use of the varied abrading features of the device: The applicator nub for delicate materials. The cleansing pad for medium materials. The lifting pad for lifting pre or post treatment stain debris. And the scrubbing pad for more robust or durable materials.

Yet another embodiment or offering of the present invention is as depicted in FIG. 4. Being presented to the public as one, or both of, refillable or factory sealed separate device(s) with a singular nub on one end and a cleansing pad on the other end. Unique due to its octa-rectangular geometry and high capacity it is an even more compact size for users who only want instant access to one formulation but higher capacity, compact size, and longer use than dissimilar devices.

It is yet another objective of the present invention to provide an applicator for a treatment material formulation which does not leak, deform, or dry-out when stored, which is a problem with some previous art devices.

### Formulations:

Preferred formulations include any commercial, natural, or home-made liquid formulation which can be used for stain removal or cleaning are within the scope of the present invention. The nub applicators may be used to disperse the users desired formulation of any one or combination of: water, solvents, hydrogen peroxide, soda water, vinegar, detersive enzymes, foaming agents, denture cleaning formulations, alcohol, enzymes, oxygenated or stabilized bleach, ammonia, carpet cleaner, Amodex, Zout, Shout, toilet cleaner (great for blood), emulsifiers, salts, detergents, chelators, odor absorbing components, anionic and other surfactants; Or any other number of singular elements, natural components, or marketed formulas. This utility of loading any strategically desirable formulation into the device is critical to broad spectrum efficacy and efficient stain removal as will be discussed with specific examples.

The formulations dispensed by the present invention and disclosed herein may find usage on fabrics, clothing, furniture, carpets, curtains, upholstery, textiles, or on any surface or material, whether or not, in contact with the human body. The intended surfaces are typically soft surfaces comprised of materials such as soft plastic materials, leather and textile, but may also be used on precious metals or hard surfaces such as floors, walls, ceilings, and the like.

### Utility:

In advance of the carry or storage of the present invention the user strategically and specifically chooses a formulation tailored to the anticipated stain to defeat. For example: A trauma nurse may load a formulation for bodily fluid stains. A mechanic may load a formula for petrochemical lubricant stains. A deep fryer kitchen worker may load a formulation for food-based grease or oil stains. A make-up artist may load a formulation for lipstick or foundation. A painter may load a formulation for latex or oil-based paints and stains. A floor maintenance person may load a formulation to remove scuff marks of a hardwood floor. A person with chemical sensitivities or allergies may load a home-made natural formulation. Etc.

For attacking a stained material the user chooses a reservoir(s) formulation based on the composition of stain and material. The cap covering the applicator nub is removed. The treatment material, if clothing, may be treated either on or off the body. The applicator nub is then brought into contact with the selected area of the stained material. Pushing down, against the treatment material, then allows the nub to retract slightly and the formulation flows. Wiping or otherwise moving the applicator over the selected area spreads and infuses the formulation uniformly to all parts of the treatment material and into the fibers thereof. The user then deploys one or more of the abrading features of the device to the treated area; With the applicator nub and/or with the cleansing pad, and/or with the lifting pad, and/or with the scrubbing pad, while exerting appropriate pressure and contact with the material. This process infuses the formulation deeper into the fibers of the treatment material and releases stain debris. And enhances and hastens the removal of the targeted stain. Abrading device selection and in what sequence is dependent on the delicate or robust nature of the material and stain composition.

1. A portable applicator device easily held in the hand comprising an octa-rectangular housing or any other complex geometric design with more overall reservoir(s) volume than a dissimilar tube or pen shaped device.

2. The applicator device according to claim 1 comprising formulation reservoir(s) which are sealed, refillable, or a combination of both, and of equal or unequal size.

3. The applicator device according to claim 1 comprising reservoir filler access point(s), at any place on the device, to facilitate refilling and wherein said feature may be a threaded plug, or cap, valve hole, or other leak proof design.

4. An applicator device comprising applicator nub(s) connected to reservoir(s) allowing formulation(s) to be dispersed upon the treatment materials.

5. The applicator device according to claim 4 comprising a retractable cone-shaped and flat-tipped contact area. Wherein the applicator nub(s) contact the treatment material and precisely deliver variable flow of formulation to the treatment material without wasting or overdelivering the formulation.

6. An applicator device comprising integrated abrading features used to exert additional mechanical frictional stress upon the treatment material depending on material type, stain composition, and different abrading needs.

7. The abrading features according to claim 6 comprising a bristle or scrubbing pad, anywhere on the device, for abrading stain substance on robust materials.

8. The abrading features according to claim 6 comprising a lifting pad, anywhere on the device, for dabbing and removing stain residue or other debris either before or after applying formulation and/or abrading actions.

9. The abrading features according to claim 6 comprising a cleansing pad, anywhere on the device, for abrading stain substance on standard materials.
